(19) United States
(12) Patent Application Publication
(10) Pub. No.: US 2026/0257326 A1
(43) Pub. Date: Sep. 3, 2026

(54) IMPACT DRIVER TORQUE CONTROL

(71) Applicant: Apex Brands, Inc., Apex, NC (US)

(72) Inventor: Kyle M. NEUBAUER, Lexington, SC (US)

(21) Appl. No.: 19/164,641

(22) PCT Filed: Mar. 14, 2024
(86) PCT No.: PCT/US2024/019869

§ 371 Date: Sep. 12, 2025

Related U.S. Application Data
(60) Provisional application No. 63/451,979, filed on Mar. 14, 2023.

(51) Int. Cl. B25B 23/147

(52) U.S. Cl. CPC B25B 23/1475

(57) ABSTRACT

An impact driver may include a motor which may output rotational movement, control circuitry which may control delivery of power to the motor, a spindle which may be operably coupled to the motor, a hammer which may be operably coupled to the spindle and may be and configured to move axially along the axis of rotation, and an anvil which may operably couple to an end effector for acting upon a work piece. The control circuitry may measure a parametric proxy for torque. The control circuitry may estimate an amount of torque applied to the end effector as a function of the parametric proxy.

### TECHNICAL FIELD

Example embodiments generally relate to power tool technologies and, and in particular to impact drivers and associated components.

### BACKGROUND

Impact drivers, such as an impact wrench, apply a repeating, rotational striking force onto an internal anvil to generate a rotational output that may be used to act upon a work piece, such as a fastener. This type of abrupt and recurring rotational output has proven useful in a variety of contexts, such as to remove rusted, sealed, corroded, or otherwise difficult to remove fasteners (e.g., screws, bolts, nuts, etc.), in drilling applications, and the like.

In many cases, the impacts and the torque generated by impact drivers may not be controlled. As such, often times the operator may be limited in their knowledge of how tight a fastener was, or should be, tightened. In this regard, the operator of the impact driver may use alternative tools to determine the torque level of the fastener, the operator may under-size the impact driver being used, or the operator may count the number of impacts so as to not over-torque the fastener.

Accordingly, innovation to address the technical problem of the uncertainty of the torque levels applied by impact drivers is desired.

### BRIEF SUMMARY OF SOME EXAMPLES

Some example embodiments may provide for an impact driver for driving fasteners. The impact driver may include a motor which may be configured to output rotational movement, control circuitry which may be configured to control delivery of power to the motor from a power source, a spindle which may be operably coupled to the motor and may generate rotational movement of the spindle about an axis of rotation, a hammer which may be operably coupled to the spindle and configured to move axially along the axis of rotation, an anvil which may be configured to operably couple to an end effector for acting upon a work piece. The control circuitry may measure a parametric proxy for torque. The control circuitry may estimate an amount of torque applied to the end effector as a function of the parametric proxy.

In another example embodiment, an impact assembly of a hand tool may be provided. The impact assembly may include a spindle which may be operably coupled to a motor and may generate rotational movement of the spindle about an axis of rotation, a hammer which may be operably coupled to the spindle and configured to move axially along the axis of rotation, an anvil which may be configured to operably couple to an end effector for acting upon a work piece, and control circuitry which may be configured to control the operation of the impact assembly. The control circuitry may measure a parametric proxy for torque. The control circuitry may estimate an amount of torque applied to the end effector as a function of the parametric proxy.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a functional block diagram of an impact driver according to some example embodiments;

FIG. 2 illustrates an impact assembly for an impact driver shown in a section view according to some example embodiments;

FIG. 3 illustrates an impact assembly for an impact driver shown in a section view according to some example embodiments;

FIG. 4A illustrates a distance sensor for an impact assembly shown in a perspective view according to some example embodiments; and

FIG. 4B illustrates a distance sensor for an impact assembly shown in a perspective view according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

According to some example embodiments, an improved impact driver or other power tool is provided. The current state of impact drivers dictates that the amount of torque applied to a work piece may be difficult to determine during the operation of the impact driver. In this regard, improperly torqueing the work piece may be a recurring theme for an operator of an impact driver. In some cases, in order to avoid improperly torqueing the work piece, the operator of the impact driver may intentionally elect to be conservative and use a smaller impact driver than normal so that the work piece or the object to which the work piece is operably coupled do not get damaged as a result of operating the impact driver. In other cases, the operator of the impact driver may elect to use a torque stick which may flex when impacted and may be calibrated at a set speed. In still some other cases, the operator of the impact driver may estimate torque on the work piece by counting impact quantity or by estimating the amount of rotation of the work piece after impacting begins. Thus, the improved impact driver described herein may include control circuitry configured to estimate the amount of torque applied to the work piece via measuring a parametric proxy for torque, and may control the operation of the impact driver based on the amount of torque that is determined to be applied to the work piece. As such, the previous methods for estimating torque may be avoided, and reaction torque to the operator may be reduced, for more convenient and consistent operation of the impact driver.

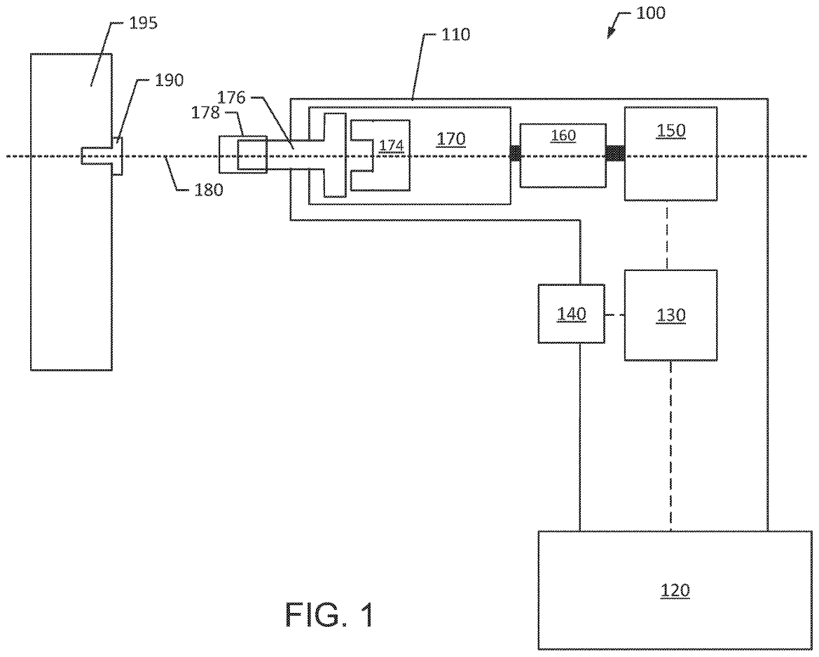

Having described some aspects of example embodiments generally, FIG. 1 illustrates a functional block diagram of an impact driver 100 to provide context according to some example embodiments. The impact driver 100 may be an impact wrench, impact drill, or other impact-based rotating power tool. The impact driver 100 may include an external housing 110, within which various operational components may be disposed. In this regard, the impact driver 100 may be powered by a power source, such as, for example, a rechargeable battery 120. The battery 120 may be configured to provide electrical power to the control circuitry 130 and the motor 150. The control circuitry 130 may receive a control signal from the control switch 140 (e.g., trigger) and may respond by permitting controlled electrical power to be provided to the electric motor. Note that while the impact driver 100 is described as being an electrical power tool, it is understood that the impact driver 100 may also be embodied as other types of power tools, such as, for example, pneumatic power tools.

As mentioned above, the impact driver 100 may include a motor 150 configured to output rotational movement, which in some embodiments, may be the electric motor. Thus, the electric motor may be configured to output a rotational movement, via a shaft, to a gear assembly 160. The gear assembly 160 may include various gearing for changing a rotational speed of the electric motor to a desired rotational speed for output by the gear assembly 160. Accordingly, the rotational output of the gear assembly 160 may be an input to an impact assembly 170. Among other components, the impact assembly 170 may include a spindle 172, a hammer 174 and an anvil 176. The impact assembly 170 may also include gearing and other mechanical components for translating the rotational output of the gear assembly 160 into a rotational impact output of the anvil 176. In this regard, the impact assembly 170 may include, for example, a spring 171 that may bias the hammer 174 towards the anvil 176, and may accordingly store energy that is abruptly released upon the hammer 174. The spindle 172 may be operably coupled to the gear assembly 160, and thus to the motor 150, to generate rotational movement of the spindle 172 about an axis of rotation 180.

The hammer 174, which may be operably coupled to the spindle 172, may include impact faces that may extend into engagement with the anvil 176 and rotate to impact the anvil 176 to generate rotational impact movement. Such movement may be transferred through the anvil 176 to a head end of the anvil 176 that includes a drive. The drive may be shaped to operably couple to an end effector 178. The end effector 178 may be, for example, a socket, a driver bit, a drill bit, or the like. Accordingly, with the end effector 178 coupled to the drive of the anvil 176, the impact driver 100 may be configured to act upon a work piece 190 (e.g., a fastener such as a screw, bolt, nut, or the like), for example, secured in an object 195. In this regard, the abrupt and recurring rotational output evoked on the end effector 178 may operate, for example, to loosen the work piece 190 and permit removal, even when the work piece 190 is difficult to remove due to being, for example, rusted into engagement with the object 195.

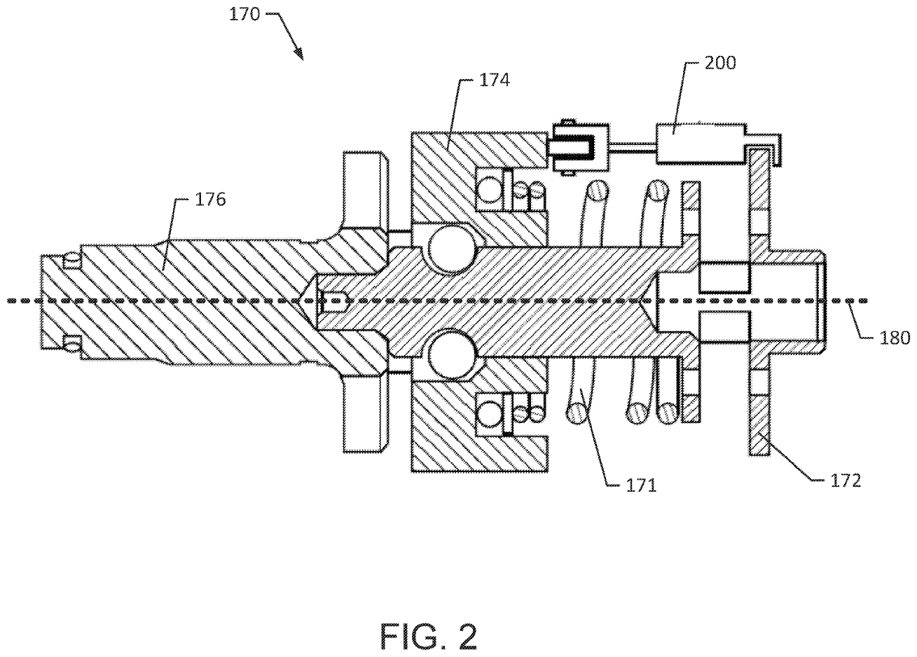

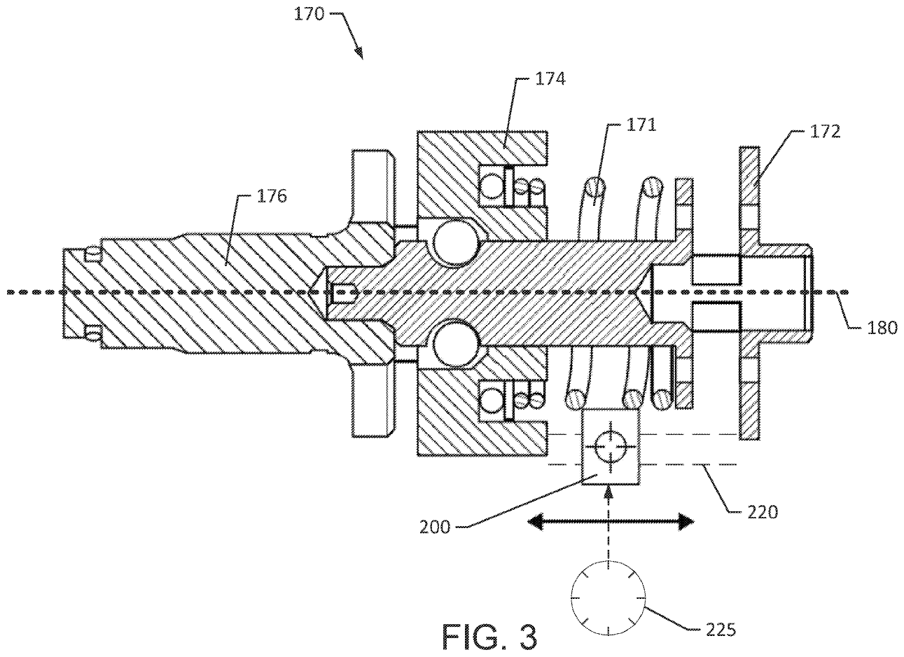

FIGS. 2 and 3 depict section views of the impact assembly 170 according to example embodiments. As mentioned above, the impact driver 100 of some embodiments may measure a parametric proxy to estimate the amount of torque applied to the work piece 190. In the embodiments of FIGS. 2 and 3, the parametric proxy for torque may be a rebound distance of the hammer 174. In this regard, the impact assembly 170 may further include a distance sensor 200. In such cases, the spindle 172 may extend from the anvil 176 at a first end, back to the gear assembly 160 at a second end, extending through a center of the hammer 174. The distance sensor 200 may be configured to measure a distance between the hammer 174 and a reference point 210. In some cases, the reference point 210 may be disposed at the second end of the spindle 172 since the hammer 174 may be configured to translate along the axis of rotation 180 relative to the spindle 172. In this regard, the hammer 174 may alternate between rebounding away from the anvil 176 (i.e. against the biasing force of the spring 171) and delivering an impact on the anvil 176. Thus, the distance sensor 200 may measure a change in the distance between the hammer 174 and the reference point 210 and may communicate that change to the control circuitry 130 as the rebound distance. The control circuitry 130 may therefore define alternative modes of operation of the impact driver 100 based on the parametric proxy such as the rebound distance of the hammer 174, and other known data points such as the rotational velocity of the motor 150.

In some cases, as described above, the reference point 210 may be disposed at a portion of the spindle 172. In this regard, the spindle 172 may be substantially cylindrical in shape, but may also include expanded circular flanges at the second end of the spindle 172 proximate to the gear assembly 160. In some other cases, the reference point 210 may be disposed at a particular location on an interior side of the external housing 110. In an example embodiment, the reference point 210 may be adjustable as well. In this regard, the distance sensor 200 may have an adjustable position. The distance sensor 200 may be operably coupled to a sliding mount 220 (i.e. a slider), and as such, the distance sensor 200 may be slidably operably coupled to the slider 220. Additionally, a torque selector 225 may be operably coupled to the distance sensor 200 to change the position of the distance sensor 200 along the slider 220. As such, the torque selector 225 may be operable by an operator of the impact driver 100 to set the reference point 210 at a desired location, thereby simultaneously defining the target rebound distance that corresponds to the desired amount of torque applied to the end effector 178.

As mentioned above, the control circuitry 130 may define alternative modes of operation of the impact driver 100. Accordingly, the control circuitry 130 may determine an amount of torque applied to the end effector 178 as a function of the rebound distance and the known rotational velocity of the motor 150. In other words, the control circuitry 130 may estimate the amount of torque output to the end effector 178 using known data such as the rotational velocity of the motor 150 and measured data such as the rebound distance of the hammer 174. In an example embodiment, the control circuitry 130 may collect other data points from the distance sensor 200 as well, such as counting the total number of rebounds of the hammer 174 in a set time interval. The rebound of the hammer 174 may be directly proportional to the energy delivery of the impact driver 100, and as such, the rebound may be useful in determining the torque delivery of the impact driver 100. For instance, the rotational velocity of the motor 150 may be a known variable, and the rebound of the hammer 174 may be a measurable variable via the distance sensor 200. Since the rebound of the hammer 174 may be proportional to the energy delivery of the impact driver 100, then it may be possible to form an estimate of the torque delivery to the end effector 178 accordingly. In this regard, the control circuitry 130 may include an algorithm capable of deducing the amount of torque output based on the above variables, and in an example embodiment, the control circuitry 130 may define alternate modes for operating the impact driver 100 that may dictate the torque output to the end effector 178.

One such mode for operating the impact driver 100 may be a duplicate mode 230. With the duplicate mode 230 engaged, the control circuitry 130 may first enter the impact driver 100 into a calibration period. During the calibration period, the distance sensor 200 may measure the rebound of the hammer 174 while the operator uses the impact driver 100 to apply torque to the work piece 190 “manually”, (i.e. the operator determines the amount of torque to apply on their own without any aid from the control circuitry 130). The control circuitry 130 may accordingly estimate the amount of torque applied to the work piece 190 using the rebound distance of the hammer 174. After the calibration period has been terminated by the control circuitry 130, the impact driver 100 may be operated to apply the same torque level determined during the calibration period to all subsequent operations of the impact driver 100 while the duplicate mode 230 may be engaged. In this regard, the impact driver 100 may be used to operate on a series of work pieces 190 that may all need to be tightened to the same torque level. During the duplicate mode 230, the control circuitry 130 may be calibrated to know the rebound distance of the hammer 174 when the impact driver 100 reaches the desired torque level, and may use the measured rebound distance as a target rebound distance during subsequent operations of the impact driver 100. In such cases, the reference point 210 may be set at a distance greater than the rebound distance, or in some cases, the reference point 210 may be disposed at the target rebound distance, as will be described below in further reference to FIGS. 2-4. In an example embodiment, the calibration period may last for two consecutive rebounds of the hammer 174. In some other cases, the calibration period may be a single rebound of the hammer 174. In an example embodiment, the calibration period may be 3 or more consecutive rebounds of the hammer 174. In this regard, more consecutive rebounds that the calibration period includes may generally lead to a more accurate torque estimate from the control circuitry 130. Taking a greater sample size of rebounds may be how the distance sensor 200 and the control circuitry 130 filter out signal errors in the system. For instance, a signal error may be a rebound that doesn't reach the target rebound distance in between two rebounds that do. Due to collecting more data points, the control circuitry 130 may determine the torque level with greater accuracy and consistency.

The control circuitry 130 may further define a shutoff mode 240 for operating the impact driver 100. In the shutoff mode 240, the operator may input a predetermined set point that may correspond to the desired torque level into the control circuitry 130. Similar to the desired torque level from the duplicate mode 230, the predetermined set point in the shutoff mode 240 may correspond to a target rebound distance of the hammer 174. Responsive to the distance sensor 200 measuring the hammer 174 rebound at the target rebound distance, the control circuitry 130 may determine that the predetermined set point for the output torque has been reached and may thus power off the motor 150 accordingly. In an example embodiment, the reference point 210 may be set at a distance greater than the rebound distance, or in some cases, the reference point 210 may be disposed at the target rebound distance. In this regard, the reference point 210 may be adjusted by the operator, which may therefore also adjust the target rebound distance and the predetermined set point in some embodiments. Similar to the duplicate mode 230, the shutoff mode 240 may also require at least two consecutive rebounds of the hammer 174 to the target rebound distance before powering off the motor 150 in order to minimize any signal errors in the system.

In an example embodiment, either the duplicate mode 230 or the shutoff mode 240 may also utilize additional variables when determining the torque output to the end effector 178. In this regard, the control circuitry 130 may further be configured to count a total number of rebounds of the hammer 174. Accordingly, in the duplicate mode 230, the control circuitry 130 may count the total number of rebounds during the calibration period, and may duplicate the same number of impacts during each subsequent operation of the impact driver 100 while the duplicate mode 230 is engaged. With respect to the shutoff mode 240, the control circuitry 130 may count the total number of rebounds to reach the predetermined set point, and may also determine when the amount of torque applied to the end effector 178 reaches the predetermined set point by counting the total number of rebounds in each subsequent operation. It should be noted that the above described duplicate mode 230 and shutoff mode 240 are only two examples of different operating modes for the impact driver 100 and do not define an exhaustive list of modes. Any number of additional modes utilizing the control circuitry 130 and the distance sensor 200 may be implemented into the impact driver 100 to define additional ways to improve the operation of the impact driver 100.

Different types of distance sensors 200 may be utilized in different embodiments of the impact driver 100, and for the different operating modes as well. In this regard, the distance sensor 200 may in some cases be a variable distance sensor 202. As shown in FIG. 2, the variable distance sensor 202 may be operably coupled to each of the components that move relative to each other and whose distance apart is desired to be measured. In the case of FIG. 2, the desired distance may be the rebound distance of the hammer 174, and so the variable distance sensor 202 may be operably coupled to the hammer 174 at a first end and to the reference point 210 at a second end. The variable distance sensor 202 may measure any rebound distance up to and including a maximum extension of the variable distance sensor 202. In this regard, the variable distance sensor 202 may be embodied as a piston or a strut of some kind, as shown in FIG. 2. In some other cases, the variable distance sensor 202 may be embodied as a light-based distance sensor, which may be configured to measure the distance between the hammer 174 and the reference point 210. The variable distance sensor 202 may output a numerical value for the displacement of the hammer 174 relative to the spindle 172.

In some cases, such as the embodiment depicted in FIG. 3, the distance sensor 200 may be a static distance sensor 204. The static distance sensor 204, as opposed to the variable distance sensor 202, may be disposed at a reference point 210 operably coupled to a particular location on an interior side of the external housing 110. In an example embodiment, the static distance sensor 204, and thus the reference point 210, may be adjustable as well. In this regard, the static distance sensor 204 may be disposed on the adjustable reference point member 220. The adjustable reference point member 220 may be a sliding mount, and as such the static distance sensor 204 may be slidably operably coupled to the adjustable reference point member 220. Additionally, a selector 225 may be operably coupled to the adjustable reference point member 220. As such, the selector may be operable by an operator of the impact driver 100 to set the reference point 210 at a desired location. In such cases, rather than measure the precise hammer 174 rebound distance, the static distance sensor 204 may simply detect whether or not the hammer 174 rebounds to the reference point 210.

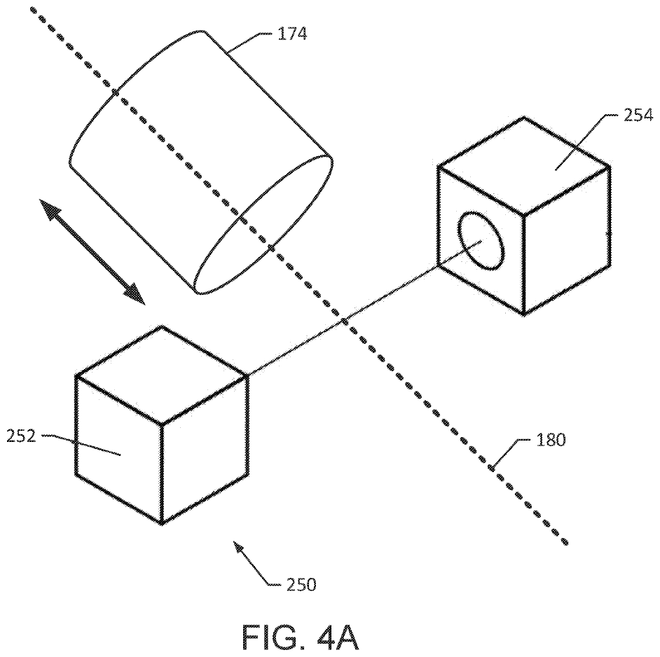

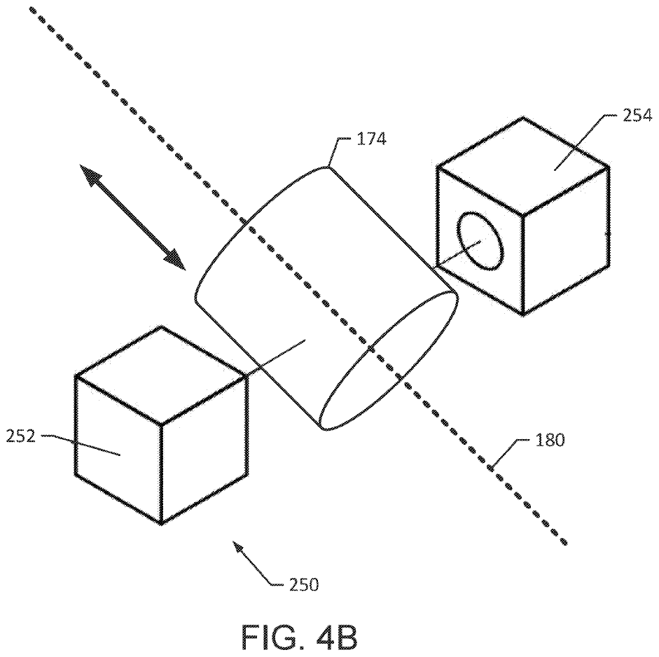

For example, in some cases, the static distance sensor 204 may be a light switch 250 such as the distance sensor 200 depicted in FIGS. 4A and 4B. The light switch 250 may include a light source 252 and a light receiver 254, which may each be disposed at the reference point 210, a known distance away from the hammer 174, and on opposing sides of the hammer 174. The light switch 250 may then alternate between an on state (FIG. 4A) and an off state (FIG. 4B), and may communicate its current state to the control circuitry 130 accordingly. In this regard, the light switch 250 may be in the on state responsive to the hammer 174 being in any position between its resting position proximate to the anvil 176, and the reference point 210. As soon as the hammer 174 reaches the reference point 210, the hammer 174 may interrupt a light beam extending from the light source 252 to the light receiver 254. Responsive to this, the light switch 250 may enter the off state, which may indicate that the hammer 174 rebound has reached the reference point 210.

Some embodiments may include a plurality of distance sensors 200. In this regard, the impact assembly 170 may include a plurality of distance sensors 200 consecutively disposed one after another at various reference points 210. In some cases, the plurality of distance sensors 200 may include static distance sensors 204 such as light switches 250. The light switches 250 may be disposed as described above relative to the hammer 174. Thus, as the hammer 174 rebounds away from the anvil 176, the hammer 174 may block the light switches 250 up to the rebound distance. Thus the control circuitry 130 may determine the rebound distance (and therefore the torque output to the end effector 178) responsive to determining which distance sensors 200 of the plurality of distance sensors 200 may be in the on state and which may be in the off state.

As can be appreciated above, one example of a parametric proxy for an electrically driven impact driver 100 may be the rebound distance measured by a distance sensor 200. However in some other cases, the impact driver 100 may be pneumatically operated, rather than electrically operated. A pneumatic impact driver 100 may rely on pressurized air to power the motor 150 rather than the battery 120 from the electric impact driver 100. In such cases, the torque applied to the work piece 190 may be more accurately estimated by tracking the opening of a valve as the parametric proxy for torque. The valve may open to different degrees (i.e. 50% open) and/or for different durations of time (i.e. open for 2 seconds) to control the flow of air from a source of the pressurized air into the impact driver 100 and to the motor 150, responsive to operation of the control switch 140. In this regard, the pneumatically operated impact driver 100 may not rely on a distance sensor 200 to measure the rebound distance of the hammer 174 to estimate the torque applied to the work piece 190. Instead, the pneumatically operated impact driver 100 may include a switch (or another similar form of position indicator) to indicate the position of the valve and to communicate the same to the control circuitry 130. Accordingly, the control circuitry 130 may include an algorithm capable of deducing the amount of torque output based on the above variables. Similar to the electrically operated impact driver 100, the control circuitry 130 of the pneumatically operated impact driver 100 may also define alternate modes for operating the impact driver 100 that may dictate the torque output to the end effector 178, such as the duplicate mode 230 and/or the shutoff mode 240, which may allow the control circuitry 130 to control operation of the valve in order to apply the desired amount of torque to the work piece 190 via the end effector 178.

Some example embodiments may provide for an impact driver for driving fasteners. The impact driver may include a motor which may be configured to output rotational movement, control circuitry which may be configured to control delivery of power to the motor from a power source, a spindle which may be operably coupled to the motor and may generate rotational movement of the spindle about an axis of rotation, a hammer which may be operably coupled to the spindle and configured to move axially along the axis of rotation, an anvil which may be configured to operably couple to an end effector for acting upon a work piece. The control circuitry may measure a parametric proxy for torque. The control circuitry may estimate an amount of torque applied to the end effector as a function of the parametric proxy.

The impact driver of some embodiments may include additional features, modifications, augmentations and/or the like to achieve further objectives or enhance performance of the impact driver. The additional features, modifications, augmentations and/or the like may be added in any combination with each other. Below is a list of various additional features, modifications, and augmentations that can each be added individually or in any combination with each other. For example, a distance sensor may measures a distance between the hammer and a reference point. In an example embodiment, the hammer may alternate between rebounding away from the anvil and delivering an impact on the anvil. In some cases, the parametric proxy may be a rebound distance defined by a change in the distance between the hammer and the reference point measured by the distance sensor. In an example embodiment, the control circuitry may include a duplicate mode for operating the impact driver. In some cases, in the duplicate mode the control circuitry may determine the amount of torque applied to the end effector during a calibration period and may allow the impact driver to replicate the amount of torque for subsequent operations of the impact driver while in the duplicate mode. In an example embodiment, the duration of the calibration period may be two rebounds of the hammer. In some cases, the control circuitry may further include a shut-off mode in which the control circuitry may power off the motor responsive to the amount of torque applied to the end effector reaching a predetermined set point. In an example embodiment, the control circuitry may require at least two consecutive rebounds of the hammer to a target rebound distance in order to power off the motor. In some cases, the target rebound distance may correspond to the predetermined set point. In an example embodiment, the control circuitry may count a total number of rebounds required to reach the predetermined set point. In some cases, the control circuitry may determine that the amount of torque applied to the end effector in subsequent operations of the impact driver may have reached the predetermined set point by counting the total number of rebounds in each subsequent operation. In an example embodiment, the distance sensor may be a light switch. In some cases, the reference point may be disposed a known distance away from the hammer. In an example embodiment, the light switch may alternate between an on state and an off state based on a position of the hammer. In some cases, a plurality of distance sensors may be disposed at different reference points. In an example embodiment, the control circuitry may determine the rebound distance of the hammer responsive to determining which distance sensors of the plurality of distance sensors may be in the on state and which may be in the off state. In some cases, a position of the distance sensor may be adjustable. In an example embodiment, the distance sensor may be disposed on a slider. In some cases, a torque selector may be operably coupled to the distance sensor to change the position of the distance sensor along the slider. In an example embodiment, the torque selector may be operable by an operator of the impact driver to set the reference point, and thus the amount of torque applied to the end effector. In some cases, the impact driver may be pneumatically operated. In an example embodiment, a valve may control airflow between a source of pressurized air and the motor of the impact driver. In some cases, the parametric proxy may be a duration or degree of the valve opening.

Some example embodiments may provide for an impact assembly of a hand tool. The impact assembly may include a spindle which may be operably coupled to a motor and may generate rotational movement of the spindle about an axis of rotation, a hammer which may be operably coupled to the spindle and configured to move axially along the axis of rotation, an anvil which may be configured to operably couple to an end effector for acting upon a work piece, and control circuitry which may be configured to control the operation of the impact assembly. The control circuitry may measure a parametric proxy for torque. The control circuitry may estimate an amount of torque applied to the end effector as a function of the parametric proxy.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. An impact driver comprising:
a motor configured to output rotational movement;
control circuitry configured to control delivery of power to the motor from a power source;
a spindle operably coupled to the motor to generate rotational movement of the spindle about an axis of rotation;
a hammer operably coupled to the spindle and configured to move axially along the axis of rotation; and
an anvil configured to operably couple to an end effector for acting upon a work piece;
wherein the control circuitry is configured to measure a parametric proxy for torque, and
wherein the control circuitry estimates an amount of torque applied to the end effector as a function of the parametric proxy.

2. The impact driver of claim 1, wherein a distance sensor measures a distance between the hammer and a reference point,
wherein the hammer alternates between rebounding away from the anvil and delivering an impact on the anvil, and
wherein the parametric proxy is a rebound distance defined by a change in the distance between the hammer and the reference point measured by the distance sensor.

3. The impact driver of claim 2, wherein the control circuitry comprises a duplicate mode for operating the impact driver,
wherein in the duplicate mode the control circuitry determines the amount of torque applied to the end effector during a calibration period and allows the impact driver to replicate the amount of torque for subsequent operations of the impact driver while in the duplicate mode.

4. The impact driver of claim 3, wherein a duration of the calibration period is two rebounds of the hammer.

5. The impact driver of claim 2, wherein the control circuitry comprises a shut-off mode in which the control circuitry powers off the motor responsive to the amount of torque applied to the end effector reaching a predetermined set point.

6. The impact driver of claim 5, wherein the control circuitry requires at least two consecutive rebounds of the hammer to a target rebound distance in order to power off the motor, and
wherein the target rebound distance corresponds to the predetermined set point.

7. The impact driver of claim 5, wherein the control circuitry counts a total number of rebounds required to reach the predetermined set point, and
wherein the control circuitry determines that the amount of torque applied to the end effector in subsequent operations of the impact driver has reached the predetermined set point by counting the total number of rebounds in each subsequent operation.

8. The impact driver of claim 2, wherein the distance sensor is a light switch,
wherein the reference point is disposed a known distance away from the hammer, and
wherein the light switch alternates between an on state and an off state based on a position of the hammer.

9. The impact driver of claim 8, wherein a plurality of distance sensors are disposed at different reference points, and
wherein the control circuitry determines the rebound distance of the hammer responsive to determining which distance sensors of the plurality of distance sensors are in the on state and which are in the off state.

10. The impact driver of claim 8, wherein a position of the distance sensor is adjustable.

11. The impact driver of claim 10, wherein the distance sensor is disposed on a slider,
wherein a torque selector is operably coupled to the distance sensor to change the position of the distance sensor along the slider, and
wherein the torque selector is operable by an operator of the impact driver to set the reference point, and thus the amount of torque applied to the end effector.

12. The impact driver of claim 1, wherein the impact driver is pneumatically operated,
wherein a valve controls airflow between a source of pressurized air and the motor of the impact driver, and
wherein the parametric proxy is a duration or degree of the valve opening.

13. The impact driver of claim 12, wherein the control circuitry comprises a duplicate mode for operating the impact driver,
wherein in the duplicate mode the control circuitry determines the amount of torque applied to the end effector during a calibration period and allows the impact driver to replicate the amount of torque for subsequent operations of the impact driver while in the duplicate mode.

14. The impact driver of claim 12, wherein the control circuitry comprises a shut-off mode in which the control circuitry cuts off airflow to the motor responsive to the amount of torque applied to the end effector reaching a predetermined set point.

15. An impact assembly of a hand tool, the impact assembly comprising:
a spindle operably coupled to a motor to generate rotational movement of the spindle about an axis of rotation;
a hammer operably coupled to the spindle and configured to move axially along the axis of rotation;
an anvil configured to operably couple to an end effector for acting upon a work piece; and
control circuitry configured to control operation of the impact assembly,
wherein the control circuitry is configured to measure a parametric proxy for torque, and
wherein the control circuitry estimates an amount of torque applied to the end effector as a function of the parametric proxy.

16. The impact assembly of claim 15, wherein a distance sensor measures a distance between the hammer and a reference point,
wherein the hammer alternates between rebounding away from the anvil and delivering an impact on the anvil, and
wherein the parametric proxy is a rebound distance defined by a change in the distance between the hammer and the reference point measured by the distance sensor.

17. The impact assembly of claim 16, wherein the control circuitry comprises a duplicate mode for operating the hand tool,
wherein in the duplicate mode the control circuitry determines the amount of torque applied to the end effector during a calibration period and configures the hand tool to replicate the amount of torque for subsequent operations of the hand tool while in the duplicate mode.

18. The impact assembly of claim 17, wherein a duration of the calibration period is two rebounds of the hammer.

19. The impact assembly of claim 16, wherein the control circuitry further comprises a shut-off mode in which the control circuitry powers off the motor responsive to the amount of torque applied to the end effector reaching a predetermined set point.

20. The impact assembly of claim 19, wherein the control circuitry requires at least two consecutive rebounds of the hammer to a target rebound distance in order to power off the motor, and
wherein the target rebound distance corresponds to the predetermined set point.

21-28. (canceled)
